(19) United States
(12) Patent Application Publication
(10) Pub. No.: US 2002/0099809 A1
(43) Pub. Date: Jul. 25, 2002

(54) Method for providing integrated user management environment to multi-internet service and system for the same

(75) Inventor: Han Soo Lee, Seoul (KR)

Correspondence Address: FLESHNER & KIM, LLP, P.O.Box 221200, Chantilly, VA, 20153-1200, US

(73) Assignee: Lycos Korea, Inc.

(21) Appl. No.: 09/855,527

(22) Filed: May 16, 2001

(30) Foreign Application Priority Data
May 17, 2000 (KR) 2000-26426
Oct. 11, 2000 (KR) 2000-59814

(51) Int. Cl. G06F 15/173

(52) U.S. Cl. 709/223

(57) ABSTRACT

Method and system for providing an integrated user management environment to multi-Internet service, the method including the steps of (1) making a user's client system to login a member management domain provided in a web service of a main server system for using a particular internet service, (2) providing a required single user ID information to the member management domain, (3) making the member management domain to authenticate the provided user ID information, (4) transferring specific information on the authenticated user from the member management domain to the user's client system, and (5) making the user's client system to login a service domain provided from a service server system by using the specific information, whereby providing the user with one of multi-Internet service in a portal service by using the single ID information only, whereby permitting the user to login multi-Internet service by using only one ID under the same user environment, and to use other services only by one time authentication for the ID.

### BACKGROUND OF THE INVENTION

1. Field of the Invention

The present invention relates to method and system for providing services through the Internet, and more particularly, to a method for providing a plurality of Internet service within a portal service, and a system for the same.

2. Background of the Related Art

The Internet comprises computers and computer networks spaced away from each other based on TCP(Transmission Control Protocol/Internet Protocol), through which various information can be shared. Though the early Internet provided services, such as electronic mail, gopher, telnet, FTP(File Transfer Protocol), and etc., it could not be used widely since it only provided text based services. However, since a new Internet service technique of the World Wide Web(hereafter called as the Web) is developed, the Internet has grown rapidly. The Web can provide information in a variety of forms(texts, images, voices and the like) based on the HTTP(HyperText Transfer Protocol), a communication protocol, and the HTML (HyperText Markup Language). And, at an early stage, though the Web provides hypertext which merely links text information by using a hyperlink which facilitates a direct movement from one information to other information, the Web can practice hypermedia which directly links images, voices and the like according to user's demand, presently. Consequently, use of the Internet, and a number of networks connected to the Internet are rapidly increased, with consequential increase of ranges and contents of information contained in the Internet. In this environment, the various present services, for example, trading is made in the Internet by using the above merits, and, other than this, there are new types of services under development. Of the various Internet services, the portal service is started at a comparatively early stage, to provide a service for searching vast information(Web pages) in the Internet according to a request by a user. As an expanded form of such a searching service, the portal service provides multiple additional services, inclusive of other Internet services existing presently, for providing the users with integrated information. For an efficient management of the expanded portal service, the multiple additional services are managed in membership basis, actually. Therefore, for allowing to use the additional services, IDs are given to every users, and an individual authentication of ID information is made every time a service login is made. However, the present method of management has a certain limitation owing to a sharp increase of use of the portal service and the various additional services included thereto. Accordingly, an improvement in the management is necessary for increasing use of the portal service and providing the portal service more efficiently, which may be summarized as follows.

First, an integrated user management environment for existing services in the portal service is necessary.

As explained before, when the user makes login to the additional services, a authentication procedure for the user is conducted. However, service servers are managed separately, such a authentication is made separately for each server. Therefore, the user undergoes an inconvenience of repeating the same work every time the user makes login to each service, with an increased probability of the authentication failure.

Second, the integrated user management environment is also necessary for the additional services included to the portal service.

Presently, as the user demands are diversified, a continuous addition of new services to the portal service is required. However, if the integrated user management environment is not ready, such addition of new services requires additional authentications, which adds inconvenience to the user. And, in a case the present services are combined for a new service, there is an additional work to carry out that different user IDs are required to be managed.

Third, a systematic management of user behavior is required.

The portal service provides the services free of charge, actually. Based on user fundamental information and behavior information obtained in the course of the services provided free of charge, directions of development of various businesses and services are fixed. However, in a state the integrated user management environment is not made, accurate information cannot be known, and modification of the present services and starting of new services are not possible.

### SUMMURY OF THE INVENTION

Accordingly, the present invention is directed to method and system for providing an integrated user management environment to multi-Internet service that substantially obviates one or more of the problems due to limitations and disadvantages of the related art.

An object of the present invention is to provide method and system for providing an integrated user management environment to multi-Internet service, which can integrate user management environment for additional services in a portal service.

Another object of the present invention is to provide method and system for providing an integrated user management environment for multiple Internet service, which can integrate user management environment for a service added to a portal service, newly.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method for providing an integrated user management environment to multi-Internet service includes the steps of (1) making a user's client system to login a member management domain provided in a web service of a main server system for using a particular internet service, (2) providing a required single user ID information to the member management domain, (3) making the member management domain to authenticate the provided user ID information, (4) transferring specific information on the authenticated user from the member management domain to the user's client system, and (5) making the user's client system to login a service domain provided from a service server system by using the specific information, whereby providing the user with one of multi-Internet service in a portal service by using the single ID information only.

The step (1) includes the steps of (1-1) making the user's client system to request the service domain for a login, and (1-2) directing the user's client system to the member management domain instead of the service domain.

The step (3) includes the steps of (3-1) making a reference to a data base server in the main server system for user ID information, and (3-2) comparing the received user ID information with the referred user ID information.

The step (4) includes the steps of (4-1) encrypting the authenticated user's specific information in the data base server, and (4-2) processing the encrypted specific information such that the encrypted specific information can be transferred to the user's client system.

The step (5) includes the step of login an internal service server domain included in a domain identical to the member management domain, or a plurality of external service server domains each having a domain different from the member management domain.

The step of login an internal service server domain includes the steps of (18-1) making the internal processing means to direct the user's client system to the internal service domain, (18-2) making the internal service domain to share the encrypted specific information provided from the user's client system, and (18-3) making the internal service domain to decrypt the shared specific information.

The step of login the plurality of external service server domains includes the steps of (19-1) making the member management domain to obtain the specific information transferred to the user by using the internal processing means, (19-2) directing the user's client system to the external service domain by using the internal processing means, (19-3) making the member management domain to transfer the obtained user specific information to the external service domain, and (19-4) making the external service domain to decrypt the transferred specific information.

After the step (5), a method for providing an integrated user management environment to multi-Internet service of the present invention further includes the step of the client system re-logging in other service domain provided from service servers of the service server system including the step of re-logging in the internal service server domain included in the portal service and the member management domain, or a plurality of external service server domain each having a domain different from the portal service domain., whereby providing the user with internal services different from each other, in multi-Internet services in the portal service, repeatedly.

The step of re-logging in the internal service server domain preferably includes the steps of making the user's client system to request the other internal service domain, making the other internal service domain to re-share the encrypted specific information transferred to the user's client system, and making the other service domain to re-decrypt the specific information, and the step of re-logging in a plurality of external service server domain preferably includes the steps of making the user's client system to request other external service domain, making the member management domain to re-obtain the specific information transferred to the user by using the internal processing means, making the internal processing means to direct the user's client system to the external service domain, making the member management domain to re-transfer the obtained user specific information to the external service domain, and making the external service domain to decrypt the transferred specific information.

A method for providing an integrated user management environment to multi-Internet service of the present invention further includes the step of registering a required member ID before the step of logging in member management domain including the steps of making the user's client system to login the membership registration domain in the web server of the main server system, providing new user ID information and other member information to the membership registration domain, verifying duplication of the user ID information, and writing the verified user ID information and other member information on the data base server in the main server system, whereby providing the user with ID information effective to whole multi-Internet service.

A method for providing an integrated user management environment to multi-Internet service of the present invention further includes the step of making the user's client system logging out of the service domain provided from service servers of the service server system, including the steps of (1) making the user's client system to request for a logging out of the service domain, (2) terminating a login maintaining environment between the user's client system and the service domain, and (3) deleting the user specific information, whereby preventing leakage of user's private information.

The step of making the user's client system logging out of the service domain further includes the steps of writing user's behaviour during the user uses the service after the step (3).

A system for providing an integrated user management environment to multi-Internet service, including a user's client system a communication thereto can be made through an external communication network, for displaying and processing various forms of information, a main server system a communication thereto can be made through an external communication network, for providing a portal service to the user's client system, and managing Internet services inclusive of the portal service and additional services in connection with the portal service on the whole, and a plurality of service server systems a communication thereto can be made through an external communication network, for providing the additional services to the user through the portal service.

The main server system includes a router for connecting the main server system to other network through the Internet, a web service part connected to the router so as to facilitate communication, for processing information to provide the portal service to the user, and a data base service part connected to the web service part so as to facilitate communication, for storage and management of information required for the portal service.

The service server system includes an internal service server system connected to the main server system so as to facilitate communication thereto, and included in the same domain, and a plurality of external service server system communication thereto can be made through the Internet, and each having a domain different from the main server system.

The internal service server system includes a router for connecting the internal service server system to other network through the Internet, and at least one service server connected to the router so as to facilitate communication for providing services different from each other.

The external service server system includes a router for connecting the external service server system to other network through the Internet, a web server connected to the router so as to facilitate communication for processing information to provide a particular service to the user, and a service server connected to the web server so as to facilitate communication for providing the particular service to the user.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a block diagram of a system for providing an integrated user management environment in accordance with a preferred embodiment of the present invention;

FIG. 2 illustrates a flow chart showing the steps for making an initial login to a service in a method for providing an integrated user management environment in accordance with a preferred embodiment of the present invention;

FIG. 3 illustrates a block diagram showing the steps for making an initial login to an internal service domain in a method for providing an integrated user management environment in accordance with a preferred embodiment of the present invention, schematically;

FIG. 4 illustrates a block diagram showing the steps for making an initial login to an external service domain in a method for providing an integrated user management environment in accordance with a preferred embodiment of the present invention, schematically;

FIG. 5 illustrates an example of the steps for making an initial login according to the method in FIG. 2;

FIG. 6 illustrates a flow chart showing the steps for encrypting verified user information in the steps for making an initial login;

FIG. 7 illustrates a flow chart showing the steps for decrypting verified user information in the steps for making an initial login;

FIG. 8 illustrates a flow chart showing the steps for making re-login to an internal service domain in a method for providing an integrated user management environment in accordance with a preferred embodiment of the present invention, schematically;

FIG. 9 illustrates a block diagram showing the steps for making re-login to an internal service domain in a method for providing an integrated user management environment in accordance with a preferred embodiment of the present invention, schematically;

FIG. 10 illustrates a flow chart showing the steps for making re-login to an external service domain in a method for providing an integrated user management environment in accordance with a preferred embodiment of the present invention;

FIG. 11 illustrates a block diagram showing the steps for making re-login to an external service domain in a method for providing an integrated user management environment in accordance with a preferred embodiment of the present invention, schematically;

FIG. 12 illustrates a diagram showing the steps for making re-login to a service domain according to FIGS. 8 and 9;

FIG. 13 illustrates a flow chart showing the steps for registering a user ID in a method for providing an integrated user management environment in accordance with a preferred embodiment of the present invention;

FIG. 14 illustrates a diagram showing an example of the steps for registering a user ID according to FIG. 13, schematically;

FIG. 15 illustrates a flow chart showing the steps for exiting from a service domain in a method for providing an integrated user management environment in accordance with a preferred embodiment of the present invention;

FIG. 16 illustrates a block diagram showing the steps for exiting from a service domain in a method for providing an integrated user management environment in accordance with a preferred embodiment of the present invention, schematically; and,

FIG. 17 illustrates a block diagram showing an example of the steps for exiting from a service domain in FIG. 15.

### DETAILED DESCRIPTION OF THE PREFERRED EMBODIMENT

Reference will now be made in detail to the preferred embodiments of the present invention, examples of which are illustrated in the accompanying drawings. In explanations of the embodiments, the same components will be given the same names and reference symbols, and explanations of which will be omitted.

In view of management efficiency, an integration or unitization of management environments of any organization is required for close link and communication between an upper system and a lower system. And, the integration /unitization of management environments is required to be applicable to changes of an existing organization size and characteristics positively and uniformly without readjustment or reintegration of the organization. And, the integrated management environment is required to have flexibility in application to a vertical integration of an external organization of a horizontal relation, i.e., a merged foreign organization. In conclusion, it can be understood that the integration/unitization of management environments is a continuous process and a result of a series of effort for raising managerial efficiency, and the flexibility of the management environment supplements the integration/unitization.

In the meantime, this principle is applicable to a portal service under an on-line environment, and the present invention provides method and system for integration of a user management environment by suggesting a technical solution. In comparison to a general organization structure, the portal service includes a basic search service and dependent multiple additional services that require authentication. Therefore, the integration/unitization of management environments may be focused on provision of a unified ID for using the additional services, a single authentication step by using the ID in using the services, and re-use of multiple services from which the step for re-authentication is omitted.

Along with such a integration/unification, adaptability and flexibility to changes of the system and managerial method itself are required. The adaptability/flexibility implies instantaneous and positive provision of an integrated service environment for an increase of a server system following addition of a new internal service thereto and an increase of an external service server following merge of an external service. In the technical solution of the present invention, by using internal processing means that uses an object-oriented language in a system management, an optimal managerial method according to which is employed, the unification/integration can be realized and the flexibility can be given. More particularly, the present invention employs a web programming technique using an object-oriented language, based on which the authentication procedure and the internal processing procedure internally act supplementary to each other in scattered system environments of the present invention. This technical feature enhances, not only an efficiency of a portal service management, but also convenience of users actually when the integrated management environment is constructed. Characteristics of the method and system for providing an integrated user management environment of the present invention will be explained in detail.

### System for Providing an Integrated User Management Environment

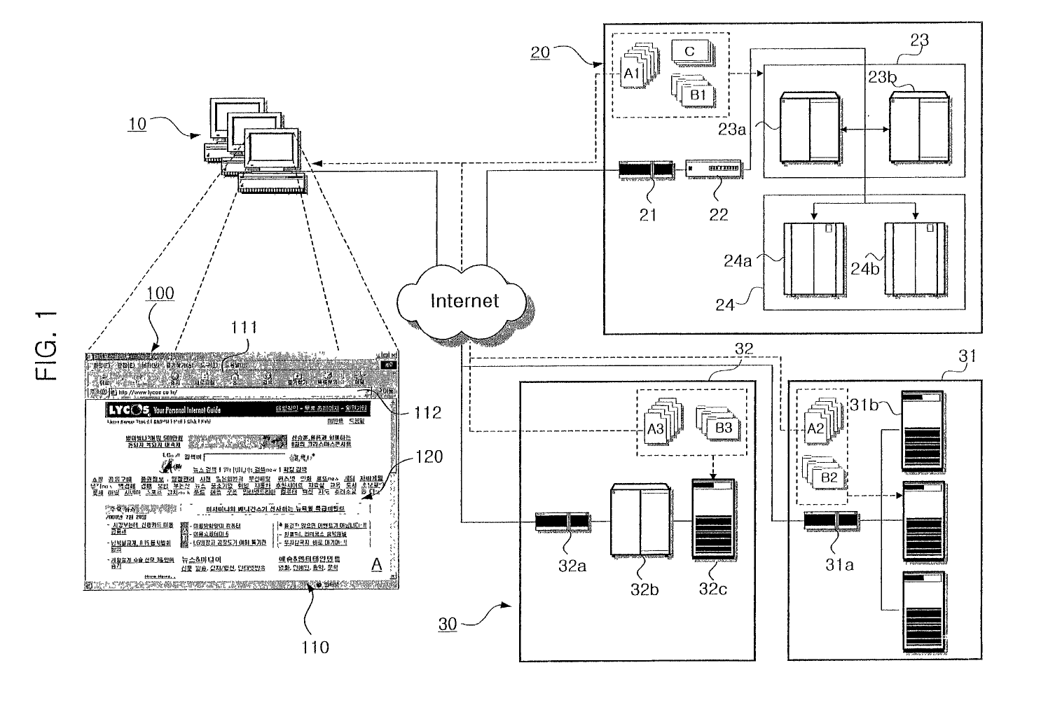

FIG. 1 illustrates a block diagram of a system for providing an integrated user management environment in accordance with a preferred embodiment of the present invention, referring to which the system of the present invention will be explained.

The system for providing an integrated user management environment in accordance with a preferred embodiment of the present invention includes different components related to computer and network technologies, i.e., hardware and software, in a fashion immaterial software exists in a material hardware. For defining correlation among the components, in the detailed description of the present invention, a “system” is used to mean inclusive of all of the different components, i.e., the hardware and the software, and a “device” means all physical components of subordinate concept excluding a collective superordinate concept, such as the system. And, “means” means all software for linking and operating the system and the device. And, in a network environment, a client is defined as a program requesting a service to other program, and a server is defined as a program providing a service in response to the request. Particularly, the hardware itself the server program is performed therein is also defined as a server, wherein, in general, though a system is managed in a fashion different programs exist in one physical server, the different programs may be spread to individual hardware basis server if the system load is heavy. In the present invention, for easy understanding and simplicity in expression, the concept of “system” defined already is used in expressing and explaining that the software basis server and the hardware basis server are in a physically combined state.

Under this premise, the system for providing an integrated user management environment in accordance with a preferred embodiment of the present invention includes client systems 10 of the users, a main server system 20 for providing a portal service to the users through the Internet, and a plurality of service server systems 30 for providing a variety of services through the portal service. The respective server systems 20 and 30 and the client systems 10 are connected to one another through the Internet to permit communication. In general, the client system 10 has operating/controlling/processing devices, a communication device, and a basic input/output devices and main/supplementary memories, so that the client system 10 has a basic capability that a communication is made with the server systems 20, 30, and 40 through the Internet, and information received in the communication is processed within the client system 10. And, interlocked with the general internal devices, the client system 10 has means for displaying and processing information from the Internet, a web browser for processing a web page, actually. In general, information in the Internet, such as characters, images, and the like, exists in numerous networks connected to web services by the Internet, and more particularly by HTTP in a form of the web pages, and is provided to different networks and computers therein in the same form(i.e., a web pages). The web page is a kind of document written in HTML, and various information is presents in the web pages by HTML tag. Each web page has an URL (Uniform Resource Locator), which consistently indicates an accessible resource address in the Internet, and not only the web page, but also the various information contained in the web page have their own URLs.

In actual information exchanges in the Internet, the client system 10 designates an URL for requesting the server system 20, 31, 32 for a particular web page A1, A2, A3, and the server system 20, 31, and 32 provides the web page A1, A2, A3 to the client system 10 upon reception of the request. As described before, as the web browser 100 is provided to a display from a memory of the client system 10, such an information exchange is made possible. One example of such a web browser user interface is illustrated in FIG. 1, referring to which the web browser user interface will be explained in detail.

The web browser user interface includes a rim part 110 and a web page display part 120, at large. The rim part 110 has a control region 111 for controlling an operation of the browser, and an address indication region 112 for displaying the URL of the web page displayed presently. And, the page display part 120 displays a web page A1, A2, and A3 received through the Internet. In requesting the web page, the user is required to provide a URL of a desired web page to the address indication region 112 and execute by using an input device, for example, a keyboard, in the client system 10. Then, upon reception of the desired web page from the server system 20, 30, and 32 according to the request, the web browser 100 decrypts an HTML code of the desired web page, for displaying the web page on the web page display part 120 in a form the user can watch. Thus, the foregoing series of information exchange steps and the web browser 100 which carries out the information exchange steps provide a capability that information in the Internet is shared to the client system 10.

Of the systems in the present invention, the main server system 20 basically provides the users with portal services, and makes an overall management for providing a variety of additional services linked to the portal services. That is, upon reception of a user's request from the web browser 100, the main server system 10 provides the web page A1 of the portal service to the client system 10, and, upon reception of a user's request for an additional service, reacts positively for providing a desired web page A2 or A3 in the same fashion. The main server system 20 includes a router 21 for connecting the main server system 20 to other network, a web service part 23 connected to the router for facilitating communication, and a data base service part 23 connected to the web service part 23 for facilitating communication.

The web service part 23 processes information required for providing the portal service to the user, i.e., the web page A1, actually. The portal service exists as an aggregate correlated web pages A1 in the web service part 23. For processing the web pages, the web servers 23a and 23b in the web service part 23 has internal processing means B1 in a form of a program. That is, the processing means B1 is a program which permits an Internet user to interact with various application servers(the data base servers 24a and 24b in the present invention) through the web servers 23a and 23b. Accordingly, when the web browser 100 of the client system 10 requests the web server 23a or 23b for a web page ‘A’ which is required to be processed dynamically by an application program, the web server 23a and 23b performs the program(i.e., internal processing means B1), and provides a result processed by the application program to the client system 10, together with the web page A1.

As such processing means(programs), though there are a variety of forms, such as CGI(Common Gateway Interface) and ASP(Active Server Page), the present invention preferably uses the JSP(Java Server Page) existing in a form of one compiled program, because the JSP is independent from an operating system, and can control a plurality of components which process given work. Particularly, since the JSP is written based on the Java, an object-oriented language, spread components, i.e., components operative in individual devices, can be controlled, actually. In conclusion, by using the JSP, the system of the present invention becomes to have a flexibility adaptable even to multi-spread system environments. And, the processing means B1 is required to be linked with a data base included in application program region for providing certain information. Therefore, the web server 23a and 23b includes data base login means C, preferably JDBC(Java Data Base Connectivity) if the processing means is the JSP.

In the meantime, it is preferable that the web service part 23 has at least two web servers 23a and 23b as a counter measure for a simultaneous login from a plurality of users, or a partial hindrance. And, the main server system 20 preferably includes a protocol spread device 22 for preventing overload caused by excessive request of users for the portal service. The protocol spread device actually controls a protocol traffic produced by web page request from client system 10 and spread to the web servers 23a and 23b, appropriately.

The data base service part 24 stores and manages information required for the portal service, and provides the required information upon reception of request from the internal processing means B1 in the web service part 23. As described before, this provision of information is carried out by the data base login means ‘C’, i.e., the JDBC, together with the internal processing means B1, and the required information is provided to the client system 10 in a form included in the web page. And, in order to prevent an important information loss caused by out of order, the data base service part 24 preferably has at least two data base servers 24a and 24b, and, in fact, the data base servers 24a and 24b copy information the other one has, to permit a stable provision of in-hand information during operation of the portal service. Thus, the main server system 20 has a system in which information search service is provided to the users basically, and a variety of additional services are provided to the users, together with the service server system 30.

As described before, of the systems in the present invention, the service server systems 30 provide users with the additional services through the portal service, and, more particularly, provide required service web page A2 and A3 interlocked with the main service system 20 upon reception of a request from the client system 10 during use of the portal service. In the system of the present invention, the service server system may be sorted as an internal service server system 31 and an external service server system 32 depending on whether the service server system shares the same domain with the portal service, i.e., the main server system 20, which actually manages the service server system.

In general, computers in the Internet communicate to one another based on TCP/IP, as the computers are actually connected to a communication destination by using their own IP addresses given to respective computers. The IP address is a group of numerals in a series divided in four steps by dots, such as ‘203. 192. 108. 12’. Numerals of 0-255 can be used in the divided numeral series, to permit its own value without duplication in the Internet on the whole. However, such IP addresses have a drawback in that the IP addresses are difficult to remember by the Internet users and identification of respective computers with different IP addresses and networks containing the computers is difficult. Accordingly, in TCP/IP network, i.e., the Internet, independent networks and domains which are logic groups defining computers in each of the network are set up, and each of the logically or physically separated networks can be identified in the Internet by giving names to the domains(called as “domain name”). The domain name is expressed in a group of hierarchal alphabet divided by dots, for an example, ‘lycos. co. kr’, wherein the hierarchy is classified as an uppermost layer, a second layer, a third layer and etc. The uppermost layer represents either a country or a character of an organization, and the second and the third layers represent an attribute of the organization and a location of the network. A more lower domain may also be used, to express the previous example in a form including a fourth layer, “www. lycos. co. kr” or “mail. lycos. co. kr” or the like.

Under the foregoing definition and system of domain, the internal service server system 31 shares the same domain with the main server system 20, i.e., the portal service, and connected thereto to permit communication. That is, the internal service server system 31 is included in the same network with the portal service of the present invention in physical and logical point of views. In more detail, the Internet service provided at the internal service server system 31 is added and provided for the portal site itself. The internal service server system 31 includes a router 31a for connection to other networks, and at least one service server 31b for providing different services. The internal service servers 31b provide users with information on multiple additional services, i.e., a web page A2, and the additional services exist as an aggregate of correlated web pages A1 in the internal service server 31b. And, for providing the additional services through the portal service, the internal service servers 31b have internal processing means B2 interlocked with the web service part 23, more particularly, with the internal processing means B1 thereof. The internal processing means B2 of the internal service server 32b has the same attribute with the internal processing means B1, except that they have different jobs to do.

Opposite to this, the external service server system 32 has a domain different from the main server system 20, i.e., the portal service. The external service system 32 is included to a network different from the portal service, and has an independent domain, such as “tripod. co. kr”, which means that the external service server system 32 is a domain of the related art having a service for itself different from the portal service of the present invention and the service is merged in the portal service of the present invention. Therefore, the external service system 31 has a router 31a for connecting the external service server system 32 to other networks through the Internet, a web server 32b connected to the router for facilitating communication, and a service server 31c connected to the web server 32b for facilitating communication. The web server 31c processes information for providing a particular service to the users, and maintains and manages its own independent domain. And, the external service server 31c provides a web page A3 for the additional service, and the external service servers 32b have internal processing means B3 interlocked with the internal processing means B1 for providing the additional services.

Though only one external service server system 32 is shown and described in the specification of the present invention for clarity of drawings and description, the service server system may be plural in the portal service of the present invention.

### Method for Providing an Integrated User Management Environment

A method for providing an integrated user management environment by using the aforementioned system will be explained with reference to the attached drawings. In explanation of the method for providing an integrated user management environment, a “subscriber” denotes a user registered for the additional services, and has not so much difference from the aforementioned user. And, “multiple Internet service” represents a plurality of additional services provided in the portal service.

### Making an Initial Login to a Service Domain

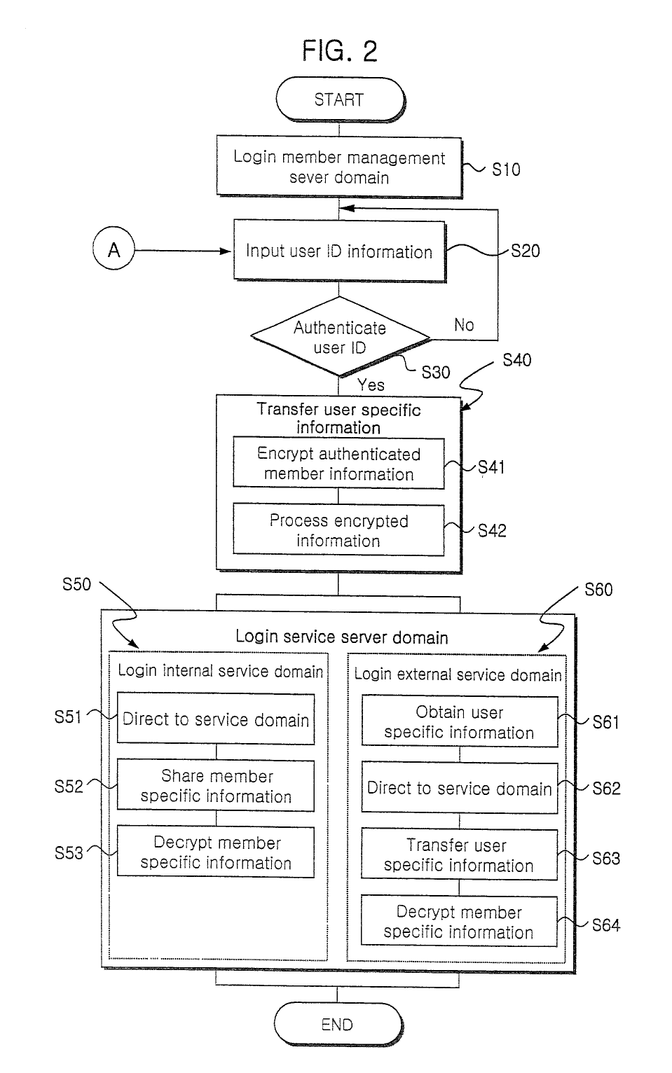

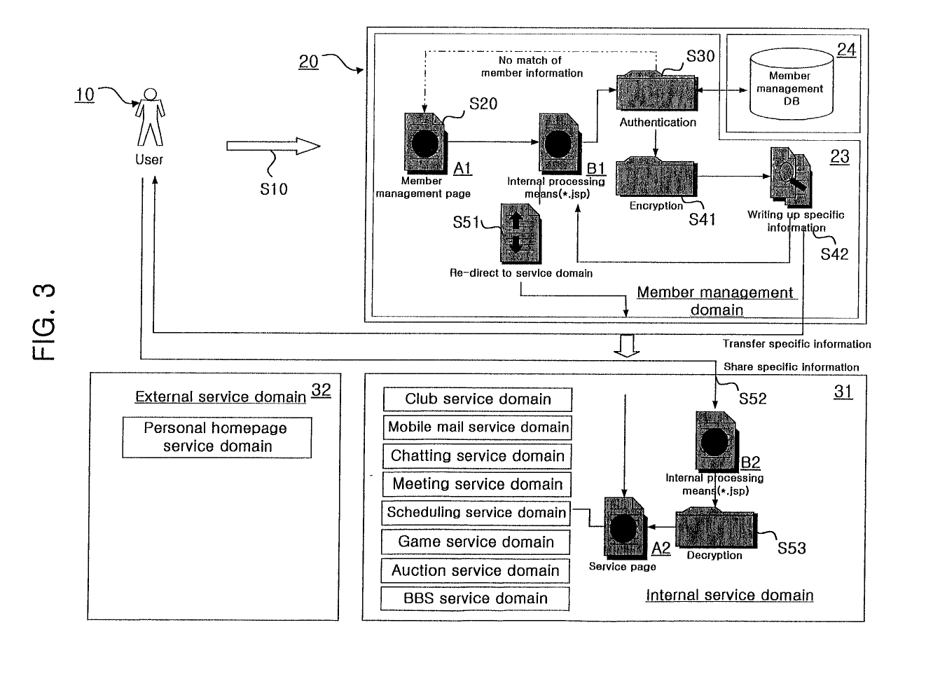

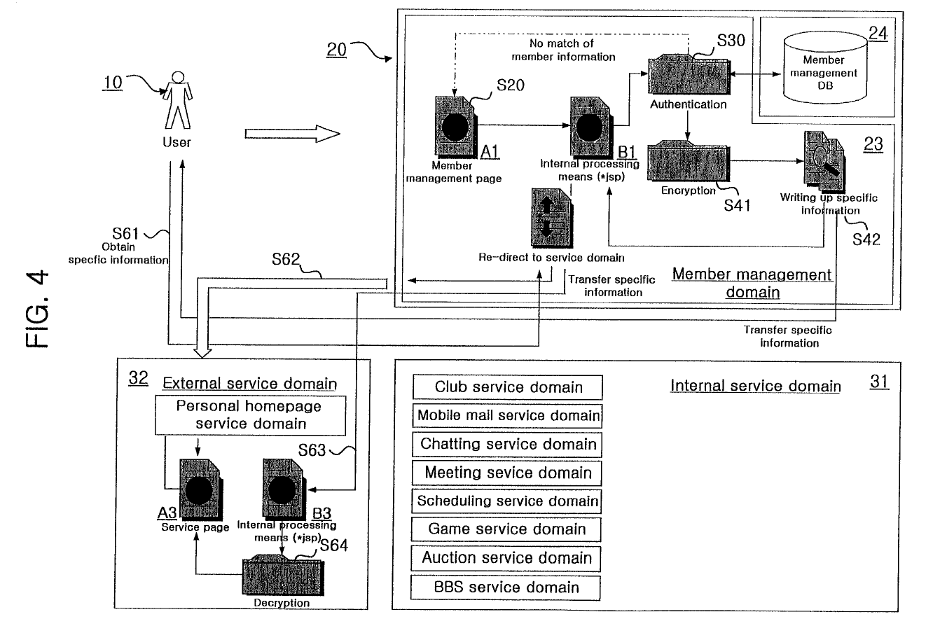

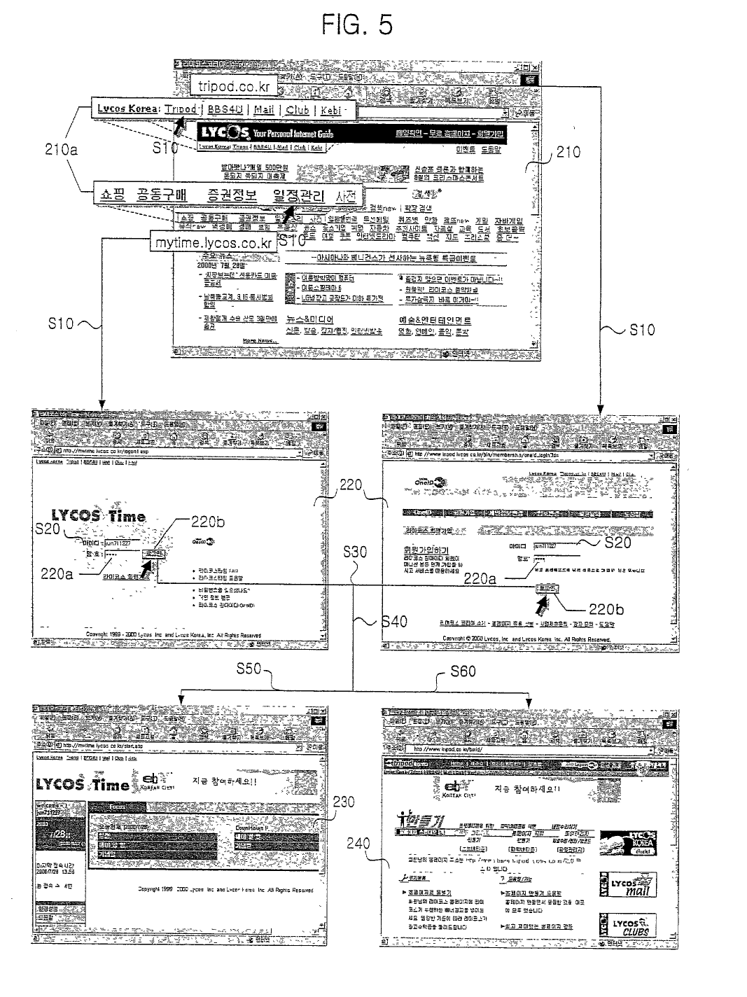

FIG. 2 illustrates a flow chart showing the steps for making an initial login to a service in a method for providing an integrated user management environment in accordance with a preferred embodiment of the present invention, FIGS. 3 and 4 illustrate block diagrams showing the steps for making an initial login to an internal service domain and an external service domain respectively in a method for providing an integrated user management environment in accordance with a preferred embodiment of the present invention schematically, and FIG. 5 illustrates an example of the steps for making an initial login according to the method in FIG. 2, referring to which the step of making an initial login will be explained in detail.

In the step of making an initial login to the service domain, the user makes an login to a user management domain among the multi-Internet services for using a particular Internet service(S10). Though the user carries out only a step of requesting a desired service in the step S10, the main server system automatically comes in during the step of requesting. That is, when the web browser 100 of the client system 10 request for a particular Internet service web page A2 and A3 in the step S10, the web service part 23 of the main server system 20 provides the user management web page Alto the web browser 100. As has been explained, the system of the present invention has separate internal and external service server systems 31 and 32, the step of requesting is made to the external and internal service domains provided from the server systems 31 and 32, selectively.

Referring to FIG. 5, in an example of the step S10, the step of requesting a desired service is made by clicking a service selection region 210a in the portal service web page 210 shown in the page indication part 120 of the browser 100. According to this, though the desired service hyper-linked to the service selection region 210a is requested by the web browser 100, the web service part 23 provides the user management web page 220 for user authentication. And, depending on user's selection in making the initial service login, the step of requesting a desired service can be made to a “scheduling” service, an internal service domain, or “personal home page(‘Tripod’ in case of lycos)” service, an external domain, individually. In detail, while the “scheduling”, one example of the service selection region 210a, has a lower level domain, “mytime. lycos. co. kr”, belonging to the same domain with the portal service name, “lycos. co. kr”, “Tripod”, a personal home page service, has a merged independent domain name “tripod. co. kr” different from the portal service. However, as shown, the independent service domain is provided as a single selection region 210a in the web page 210 of the portal service for an arbitrary selection by the user. That is, an identical environment is provided to a user's selective service request, such that the user regards even the external service domain as an unitary service without other understanding. Therefore, the present invention provides an integrated user environment to the users starting from the step of making an initial login.

After completion of the step of making an initial login, the user having logged in to the user management domain inputs required user ID information S20. The user ID information is a user ID and password, applied to an input window of the web page provided from the web service part 21. As shown in FIG. 5, the user inputs user's own user ID information to an input region 220a in the web page 220 of the member management domain displayed in the browser 100 by using an input device, such as a keyboard.

After completion of the step S20, the user ID information is authenticated through due steps S30. In this instance, when the user makes a confirmation of the input on the web page, the user's ID information is provided to the member management domain. That is, when the user clicks the confirmation region 220b in the member management web page 220 shown in FIG. 5, the web browser 100 is made to provide the ID information to the web service part 23. According to this, the authentication step is followed in succession, and, then, as shown in FIGS. 3 or 4, internal processing means of *.JSP, i.e., Java server page, conducts all steps thereafter, collectively. Since the followed steps inclusive of the authentication step are steps made internally, the followed steps may be explained in more detail with reference to FIGS. 3 and 4 illustrating internal relations between the user and the service domain. In the authentication step S30, the internal processing means B1 makes a reference to the data base service part 24 for the user ID information, and compares the received user ID information to the referred user ID information. Such a series of steps are made possible by the data base login means ‘C’, i.e., JDBC.

When the authentication step S30 is successful, specific information of the authenticated user is transferred from the member management domain to the user through a series of steps S40. In this instance, the internal processing means B1 in the web service part 23 transfers the authenticated user's specific information to the client system 20.

In the step S40, the internal service means B1 instructs relevant applications to extract the authenticated user's specific information from the data base service part 24 and encrypt the specific information S41. The encrypted specific information includes user's member ID information and at least a portion of member information. That is, as described, the user's ID information includes the user's ID and password, and the user's member information includes user's name, sex, date of birth, address and etc., provided at the time of member registration. Thus, since the specific information includes user's important information, it is preferable that the specific information is encrypted for preventing leakage of the user's personal information, and more preferably, encrypted in many steps for providing a higher security level to the Internet service itself.

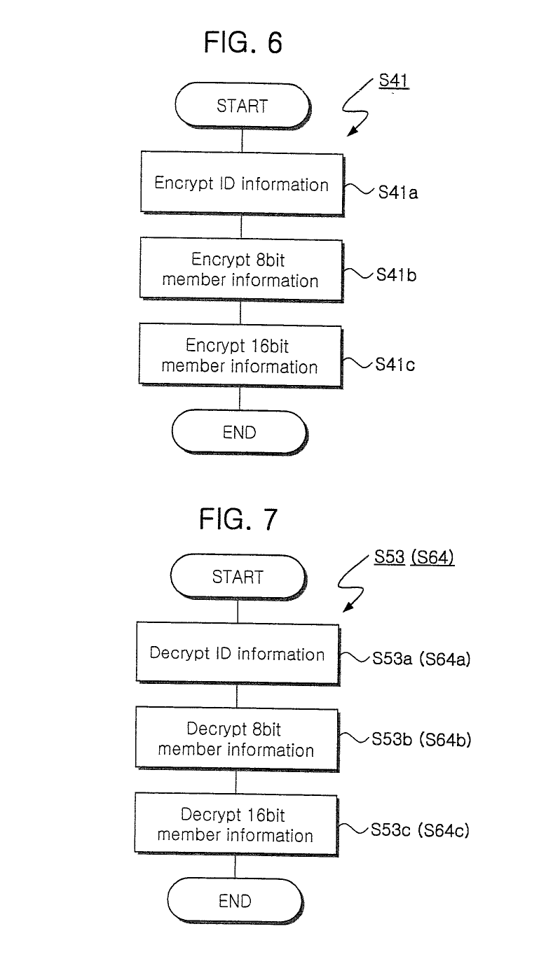

According to this, as shown in FIG. 6, in the step of encrypting the specific information, the authenticated user's ID information, i.e., user's ID and password are encrypted at first S41a. Then, 8 bit information in the specific information is encrypted(S41b). That is, it is preferable in the encrypting step S41b that 8 bit-authenticated user's ID information, such as numerals and alphabet, is encrypted once more, together with the user's member information, to enhance a security level of the user's specific information. After the encrypting step S41b, separate from the 8 bit information, 16 bit information in the specific information is encrypted S41c. Since respective encrypting steps S41a, S41b, and S41c are processed as independent modules, the separate 16 bit encrypting step S41c facilitates the method for providing a user management environment of the present invention applicable to countries which use 2 byte code characters without separate modification. In the present invention, the encrypting of the desired information in respective steps S41a, S41b, and S41c may be conducted according to a known technique in a related technical field, and, preferably, a further developed encrypting technique for enhancing the security level of the user's specific information.

The specific information passed through the entire encrypting step S41 is processed so as to be transferable to the client server 10 by the internal processing means S42. In the processing step S42, the encrypted specific information is processed in an information form called as “cookie”, and exists as a portion of the “cookie”(i.e., exists in a state combined with a basic form of cookie). The “cookie” denotes a type of information in which the web server transfers certain user's information to the user's browser and uses the user's information in a particular situation, or exchanged information itself.

In the processing step S42 of the present invention, when the user makes the initial login, the encrypted specific information is formed into a sort of “cookie” at the web service part 23 by the internal processing means B1, and stored in a web browser 100 cache in the client system 10. In more detail, the “cookie” is specified by an HTTP-Response Header received at the moment the web browser 100 makes an initial login to the web service part 23, and set up in the client system 10 by decrypting information contained in a Set-Cookie field of the header to be explained later by the web browser 100. The header has the following form.

Set-Cookies : name=VALUE;
expires=DATE;
domain=DOMAIN_NAME;
path=PATH;
secure

As shown, the Set-Cookie field has a plurality of attributes, which will be explained, briefly.

First, the name=VALUE attribute designates VALUE, a name of the cookie, required in the Set-Cookie field, essentially. And, a plurality of cookies may be set in succession, like, for an example, name1=VALUE 1; name2=VALUE2.

The expires=DATE attribute designates an expiration time point of the cookie. That is, the cookie expires on the DATE designated, and when the DATE is not designated, the cookie is expires when the web browser 100 terminates. If the web browser 100 terminates before a set time period, the cookie is stored in a storing device in the client system 10, and restored automatically when the web browser 100 is re-started.

The domain=DOMAIN_NAME attribute designates a domain name to which the web browser 100 can make an effective login. In more detail, the DOMAIN_NAME represents a domain which can receive the cookie and make the cookie effective. As far as no separate domain name is designated, a basic designated value of the DOMAIN_NAME is the web server system the cookie is made therein.

The path=PATH attribute designates a path in the domain the web browser 100 can make an effective login thereto. That is, the PATH denotes a particular location in the domain the cookie becomes effective, i.e., the URL. The cookie is transferred only when the web browser 100 requests for a URL at a level identical to, or lower than the designated PATH. If there is no separate designated path, a basic designated value of the PATH is a path(i.e., URL) of the web page in which the cookie is made.

The secure attribute a set up related to security. When the attribute is set up, the cookie can only be transmitted through a secured channel. If the attribute is not set up, a free transmission can be made without paying attention to the security.

After the attributes are set up in the client system 10, if the web browser 100 in the client system 10 request the web service part 23 for a web page additionally, the cookie can be re-transmitted to the web service part 23, together with the request. In more detail, only when the domain name and a web page path of the web page service part 23 requested in the web browser 100 are the same with the domain name and the path attribute in the stored cookie, the cookie can be re-transmitted to the web service part 23, together with the request for the web page. That is, the web browser 100 transfers the received cookie only when an login to a domain designated at the DOMAIN-NAME is made, and the cookie information is transferred only when the request for the web browser is effective with respect to the PATH.

In the foregoing login step of the present invention, the client system 10 of the user makes login to the main server system 20(actually, the web service part) initially for authentication of the user, when the client system 10 is provided with the cookie having encrypted specific information. According to this, the specific information, a cookie stored in the use's web browser 100, has a domain and path attributes effective only to the main server system 20. Therefore, according to the attribute of the cookie described previously, the user's specific information is effective for the internal service server system 31, i.e., the internal service domain throughout the whole steps of the present invention. As has been described, since the domain of the internal service system 31 is the same with domain of the main server system 20, the user's specific information can be shared by the member management domain and the internal service domain.

However, similar to the case of the foregoing internal service domain, the user's specific information is not effective for the external server system 32, i.e., the external server domain owing to the attribute of the cookie. For a user's service request, the member management domain can not know a domain name for the requested service. As described before, the domain attribute is basically set up as the member management domain, i.e., domain of the portal service, accordingly. Therefore, throughout the whole steps of the present invention, since the domain of the external service system is different from the main server system 20, it is impossible that the external service domain shares the specific information.

After completion of the step for transferring the specific information S40, the user's client system 10 makes login to a desired service server domain in the service server system 20 by using the specific information S50 and S60. In this instance, the service domain is any one of additional services in the portal service, such as mail, chatting, game.

In the step of making an initial login to a service domain of the present invention, since the foregoing series of steps S10-S40 are managed at the main server system 20 for the external and internal service domains respectively, the steps S10-S40 are proceeded in the same fashion regardless whether they share the domain or not. However, the steps of making login to the service domain S50 and S60 are proceeded in different fashions owing to characters of the service server system 30. That is, according to the service request in the member management domain login step S10, the login step S50 and S60 is divided into a step S50 for making login to internal service server domains identical to the domain of the portal service, and a step S60 for making login to a plurality of external service server domains different from the domain of the portal service. Of those login steps, the internal service domain login step S50 will be explained, with reference to FIGS. 2 and 3.

In the internal domain login step S50, at first, the user(i.e., the client system 10) is directed to a relevant internal service domain S51. That is, the internal processing means B1 re-designates a URL of the web browser 100 in the user's client system 10 to a URL of a relevant service web page A2. In FIG. 5 illustrating an example of the present invention, the user is directed to “scheduling” service web page 230 in the login step S10.

And, the service domain shares the encrypted specific information provided to the user's client system 10 S52. In the sharing step S52, the internal processing means B2 in the service server 31b requests the user's client system 10 for authenticated specific information, i.e., cookie, in the web browser 100(get cookies). According to this, the web browser 100 transfers the specific information to the service domain. As has been explained, such a direct sharing step S52 is made available as the service domain is the same with the domain of the portal site. Then, the service domain receives and decrypts the specific information S53. In this instance, the internal processing means B2 of the service server 32b instructs the decryption. According to this, as shown in FIG. 7, in the step of specific information decryption, at first, the authenticated user ID, i.e., the user ID and password are decrypted S53a. Then, one byte code in the specific information is decrypted 53b, and two byte code in the specific information is decrypted 53c, finally. According to the decrypting step S53, the service domain becomes to know the fact that the user is authenticated and the member information, so that the service domain can provide the required service.

In the meantime, the external service domain login step S60 in the login step will be explained with reference to FIGS. 2 and 3.

In the login step S60, the member management domain obtains the specific information provided from the user S61. In this instance, the internal processing means B1 in the web service part 23 brings the authenticated specific information in the web browser 100 of the client system 10, again.

Then, the user is directed to the requested external service domain S62. The user's client system 10 receives the web page A3 as the internal processing means B1 re-directs the URL of the web browser of the user's client system 10 to the external service domain. The step S62 is identical to the step S51 in the internal service domain login step. In FIG. 5, the user is directed to “home page(Tripod)” service web page 240 selected in the step S10.

Then, the member management domain transfers the obtained specific information to the external service domain S63. That is, the web service part 23(actually, the internal processing means B1) provides the obtained specific information to the service server 32c, directly. The steps S61 and S63 except the step S62 are occurred by a character of “Cookie” in which the “Cookie” can not be shared by domains different from each other, and have an effect identical to the step S52 in the step S50. As a result, while the internal service domain login step S50 is carried out to the main server system 20 independently between the client system 10 and the internal service server system 31, the external service domain login step S60 is controlled by the main server system 20 on the whole. According to this, different from the internal processing means B1, the internal processing means B3 in the external service domain merely controls decrypting step developed, successively.

After the transferring step, the transferred user's specific information is decrypted at the external service domain in a fashion identical to the internal service domain, finally S64. The decrypting steps S64a-S64c are identical to the decrypting steps S53-S54 in the internal service login step, and, alikely, the external service domain can provide the user with a desired service through the decrypting steps S64a-S64c.

According to the initial login step S10-S60 of the present invention, the user can use one of the multi-Internet services selectively in the same environment the user management domain provides by using one ID given to him. Especially, even if the domains are different, by merely transplanting the decrypting step S64 and the internal processing means B3 only, even the external service domain is integrated to the same user environment, too. That is, selection and use of the service by using only one ID is applicable to all Internet service provided within the portal service in the same fashion regardless of system difference. And, in an actual implementation of the initial login steps S10-S60, an actual convenience can be provided to the user in using the service since a requested service can be provided to the user only in two steps(220, 230/240) as shown in FIG. 5.

### Re-login to Service

After a particular service is used through the initial login steps S10-S60, the user can make a re-login to a service domain used before through required steps for using other services in the portal service. Similar to the foregoing initial login steps S10-S60, the re-login step is divided into a step S70 for making re-login to internal service domains identical to one another, and a step S80 for making re-login to a plurality of external service server domains different from one another.

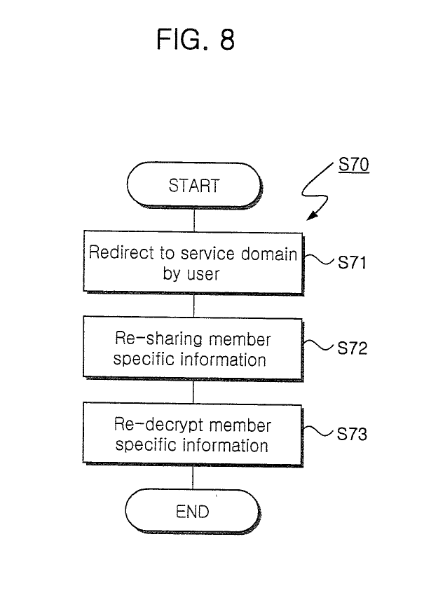

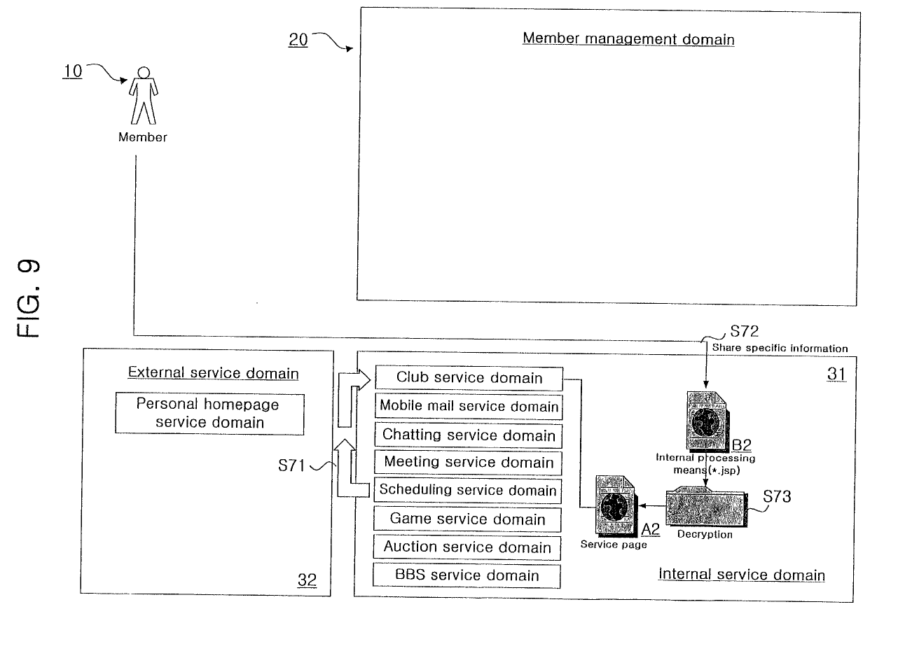

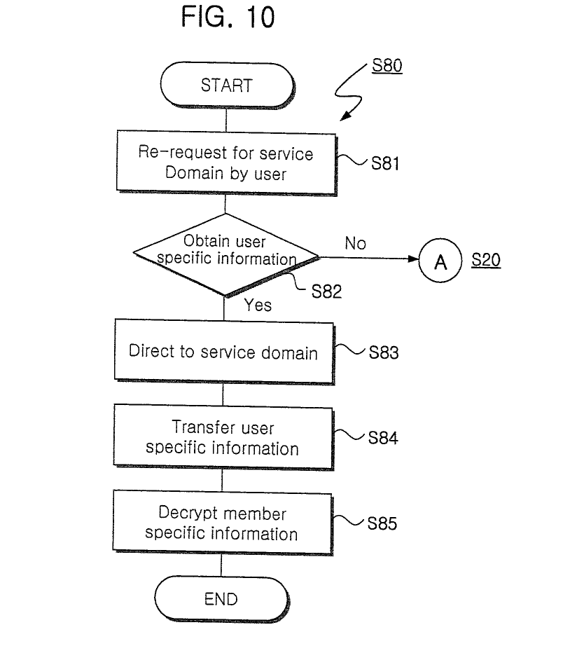

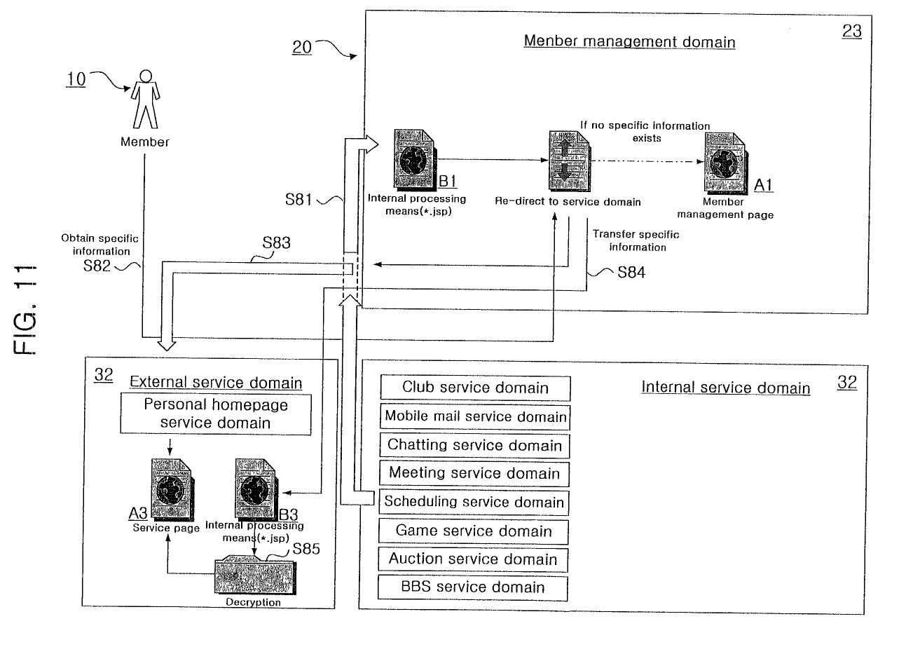

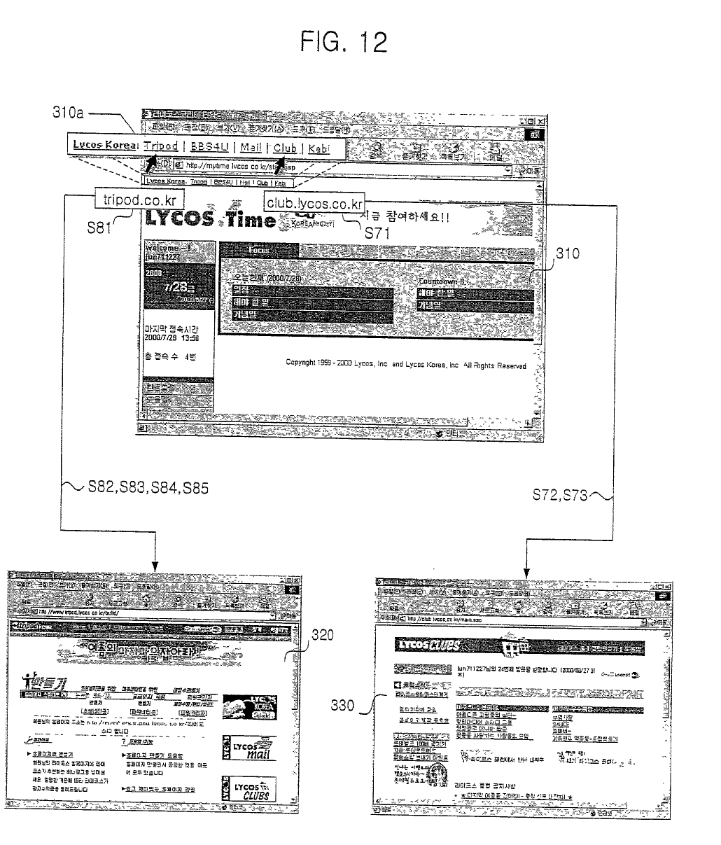

With regard to such a re-login steps, FIG. 8 illustrates a flow chart showing the steps for making re-login to an internal service domain in a method for providing an integrated user management environment in accordance with a preferred embodiment of the present invention schematically, FIG. 9 illustrates a block diagram showing the steps for making re-login to an internal service domain in a method for providing an integrated user management environment in accordance with a preferred embodiment of the present invention schematically, FIG. 10 illustrates a flow chart showing the steps for making re-login to an external service domain in a method for providing an integrated user management environment in accordance with a preferred embodiment of the present invention, FIG. 11 illustrates a block diagram showing the steps for making re-login to an external service domain in a method for providing an integrated user management environment in accordance with a preferred embodiment of the present invention schematically, and FIG. 12 illustrates a diagram showing the steps for making re-login to a service domain according to FIGS. 8 and 9. Referring to the above drawing, the external and the internal service domain login steps will be explained in detail, respectively.

Referring to FIGS. 8 and 9, in the internal service domain re-login step S70, the user requests for another service domain within the logged in service domain S71. That is, the web browser 100 of the user's client system 10 requests another service server 31b for a service web page, directly. As shown in FIG. 12, the another internal service requesting step S71 is carried out by clicking a service selection region 310a displayed on the page indication part 120 in the web browser 100. According to this, the another service hyper-linked to the selection region 310a is requested to a relevant service server 31b. In FIG. 12, the requesting step S71 is carried out at the internal service domain, and shown that the another internal service domain “clubs” service, with a domain name “club.lycos.co.kr”, is requested.

And, after the another service domain re-shares encrypted specific information provided to the user S72, the another service domain re-decrypts the provided specific information S73. Since the re-sharing step and the re-decryption step S72 and S73 are identical to the sharing and decrypting steps S52 and S53 in the initial internal service login step owing to the fact that the internal services have the same domains, a detailed description will be omitted.

And, referring to FIGS. 10 and 11, in the external service domain re-login step S80, at first, the user requests for another external service domain S81 at an logged in service domain. Different from the internal service domain login step S70 in which a re-login request is made directly to a desired service domain, the user's external service re-requesting step is carried out indirectly by the member management domain. That is, the internal processing means B1 in the web service part 23 controls the re-login step S80 developed thereafter on the whole. Alikely, in an example of the login step S80 shown in FIG. 12, the another external service requesting step S81 is carried out by clicking the service selection region 310a displayed in the page indication part 120. However, as explained, before the another external service hyper-linked to the selection region 310a is requested to relevant service server 32c, the user's client system 10 is logged in to the web service part 23 having the member management domain. In FIG. 12, it is shown that the client system 10 requests a logged in internal service domain for another external service domain “home page(tripod)” service having a domain name “tripod.co.kr”.

Thereafter, the member management domain re-obtains the specific information provided to the user S82. The obtaining step S82 in the external service re-login step S80 is carried out in a fashion identical to the foregoing obtaining step S61. In this instance, if the specific information re-obtaining step is failed, i.e., if there is no user's specific information in the client system 10, the member management domain understands the user, i.e., the client system 10 at an initial login step. According to this, the internal processing means B1 carries out the ID information input step S20 in the initial login step.

After the re-obtaining step S82, the user is directed to the requested external service domain S83, and the member management domain transfers the obtained specific information to a relevant external service domain S84. In this instance, the internal processing means B1 in the member management domain re-designate the URL for the client system 10, and transfers the obtained to a relevant service server 32c, directly.

The series of steps S81, S82, and S84 except the directing step S83 are also occurred by a character of the “cookie” in which the “cookie” can not be shared by domains different from each other. As all the steps S81-S84 are controlled by the internal processing means B1 in the member management domain, the internal processing means B3 in the external service domain merely controls a following decrypting step, only.

After the directing step S84, the transferred user's specific information is decrypted at the external service domain in a fashion identical to the foregoing decrypting steps S54 and S64, finally S64. According to this, the re-logged in external service domain becomes to know the fact of authentication and member information, to facilitate provision of the required service to the user.

According to the re-login S70 and S80, the user can make a re-login to, and use of the another service only by the authentication at the initial login, without limitation for the whole multi-Internet services in the portal service, repeatedly. Especially, similar to the initial login step, since the re-login step is carried out under the control of the member management domain (together with the transplanted decrypting step and the internal processing step), the re-login step having the same characteristics(repeatable without limitation) with the internal service domain can be carried out for the foreign external service domain, too. Such a re-login provides an actual convenience to the portal service user.

In the foregoing explanation of the re-login, even if an internal-internal, an internal-external service domain login steps only are explained, similar to this, an external-internal, and an external-external service domain re-login steps can be explained. That is, as has been explained in the initial login step and the re-login step, a form of the login is dependent on characteristics of the domain to make login thereto, more particularly, on whether the domains are the same or not. That is, regardless of a location where the login request is made, depending on whether the domains are the same or not, the login to the internal service domain is carried out by internal and direct sharing of the user's specific information, and the login to the external service domain is carried out by external and indirect pseudo-sharing of the user's specific information. Therefore, any further explanation of the above re-log in steps to the external-internal and external-external domains will be omitted as those steps are understandable without any further explanation from the above log in characteristics.

### User's ID Registration

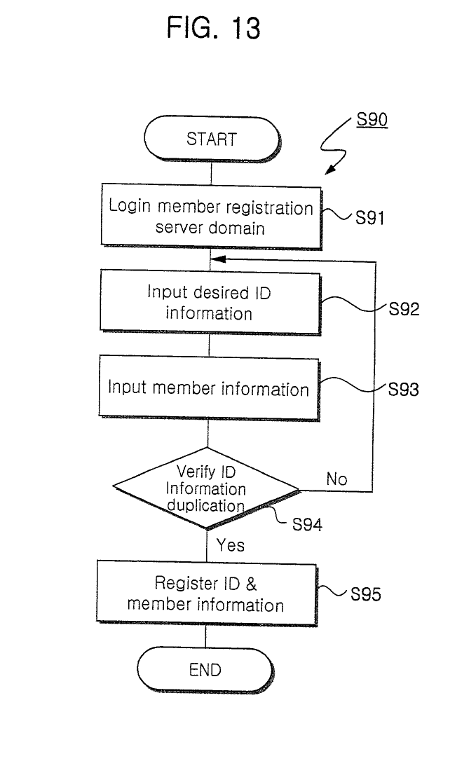

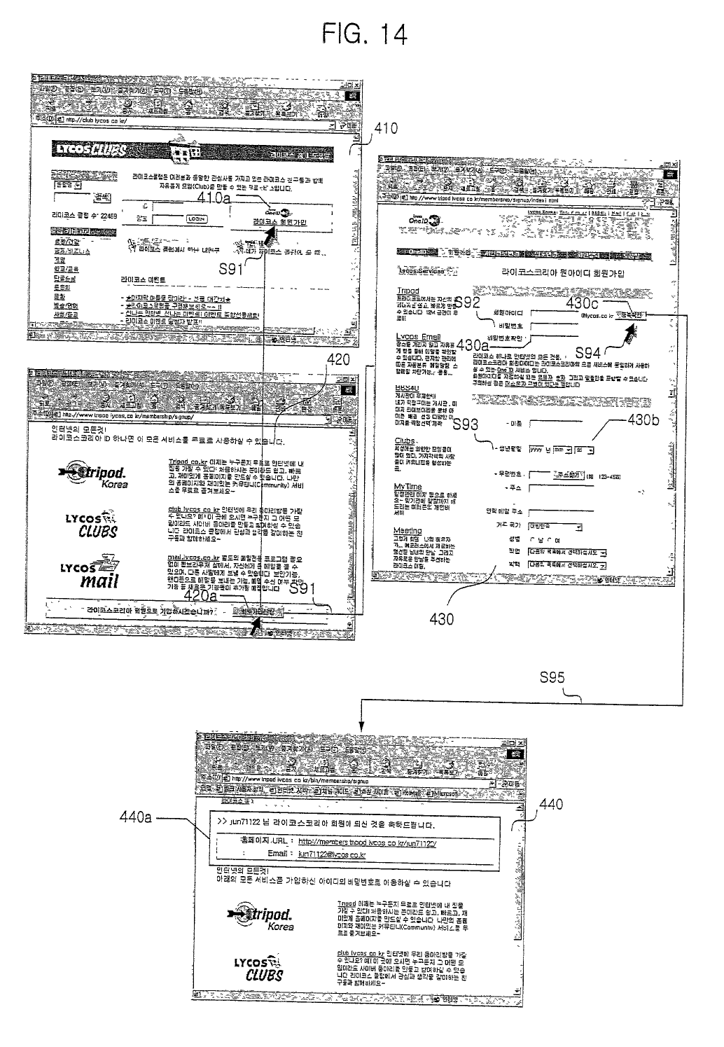

An applicant, intending to use a service provided at the portal service, is required to register a member ID before the applicant carries out the step for making login to the member management domain. FIG. 13 illustrates a flow chart showing the steps for registering a user ID in a method for providing an integrated user management environment in accordance with a preferred embodiment of the present invention, and FIG. 14 illustrates a diagram showing an example of the steps for registering a user ID according to FIG. 13 schematically, referring to which the step for making registration will be explained.

First, the applicant makes login to the member registration domain for obtaining a required user's ID S91. As shown in FIG. 14, in the login step S31, when a membership application region 410a is clicked, the web browser 100 of the user's client system 10 requests for a member registration web page 430 hyper-linked to the region. According to this, the web service part 21 of the main server system 20 transfers the web page 430 to the web browser 100. In an example of the present invention, for providing the user with a chance to determine, the login step includes a step for applying a membership made by clicking the membership application region 410a in the member management web page 410, and a confirmation step made by clicking an application confirmation region 420a in the web page 420 which explains a member service following the application.

The applicant having made login to the member registration domain provides new user ID information thereto S92, together with name, sex, age, and the like S93. In this instance, the applicant inputs the new user ID information and member information to the input regions 430a and 430b in the member registration web page 430 provided from the web service part 21 respectively by using an input device.

After completion of the input steps S92 and S93, duplication of the user's ID information with an existing user ID is verified S94. The verification step S94 is made by clicking a duplication verifying region 430c in the member registration web page 430, of which detailed explanation will be omitted since the verification step S94 is similar to the authentication step S30.

Then, the confirmed user ID information and other member information are registered S35. That is, if the verification step S94 is successful, when the confirmation region(not shown) in the web page 430 is clicked, the web browser 100 in the user's client system 10 transfers the new user ID information and member information to the web service part 23. And, the verified information is stored in data base servers 24a and 24b in the main server system 20. This fact of registration is informed to the user in a form of web page 440. As shown, it is preferable that the web page 440 includes member service information 440a on the user.

Through the foregoing steps S91-S95, the user becomes to have user an ID applicable throughout the multi-Internet services provided at the portal service in the same fashion. And, for the convenience of the user, the membership application region 410a is provided in a plurality of web pages in the portal service, for easy registration during use of the portal service.

### Service Logout

The user is permitted to use various services in the portal service freely to the user's satisfaction according to the initial login and the re-login steps S10-S80. In order to end the use of the continuous service after use of the service to the user's satisfaction, it is required to carry out logout step from the logged in service domain.

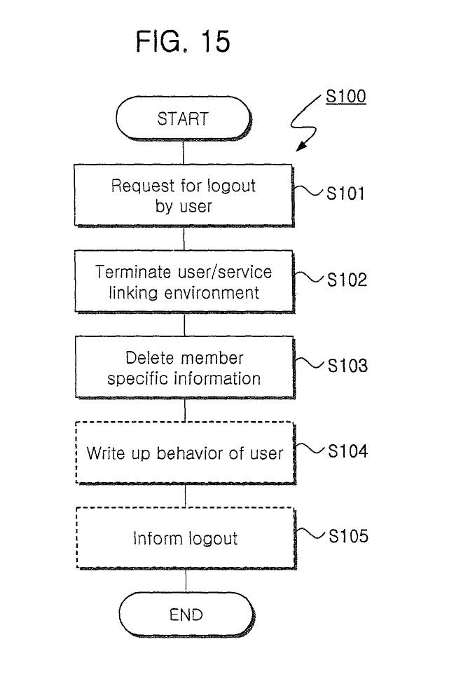

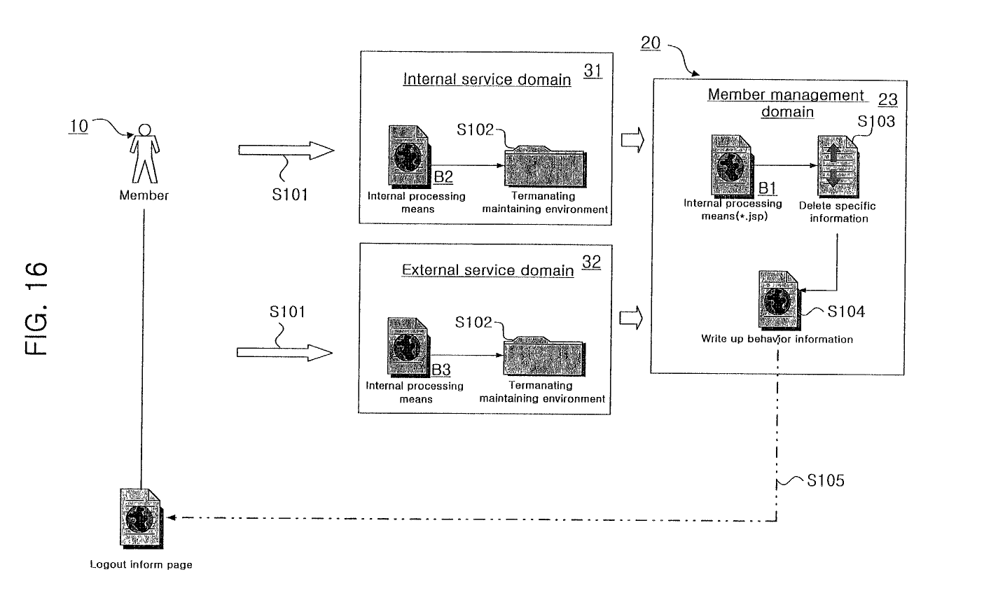

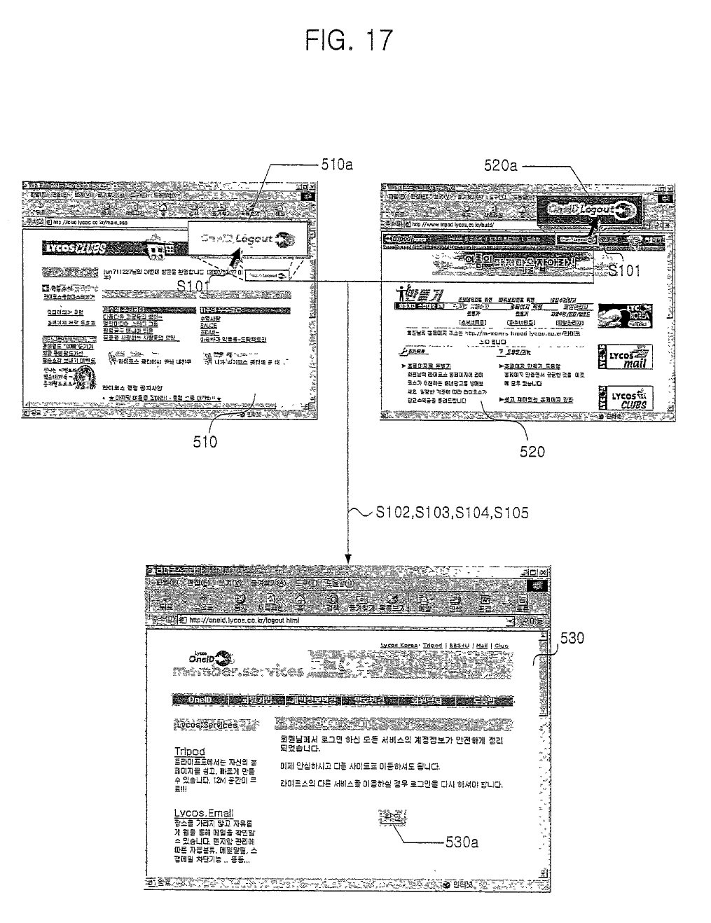

FIG. 15 illustrates a flow chart showing the steps for exiting from a service domain in a method for providing an integrated user management environment in accordance with a preferred embodiment of the present invention, FIG. 16 illustrates a block diagram showing the steps for exiting from a service domain in a method for providing an integrated user management environment in accordance with a preferred embodiment of the present invention, schematically, and FIG. 17 illustrates a block diagram showing an example of the steps for exiting from a service domain in FIG. 15, referring to which the logout step will be explained.

At first, the user requests the logged in service domain for a logout S101. That is, the user's client system 10 requests the internal processing means B2 and B3 of the logged in service server 31b and 32c to carry out a logout step through the web browser 100. As shown in FIG. 16, the step S101 for requesting logout is carried out in processes identical both for the internal and external service domains. And, as shown in FIG. 17, when the user clicks a logout region 510a and 520a in the user's web browser 100, the above requesting step S101 is conducted, to start the entire logout step S100.

After the requesting step S101, a login maintaining environment between the user's and the service domain is terminated S102. The maintaining environment terminating step S102 is carried out by respective internal processing means B2 and B3 in the external and internal service domains according to the requesting step S101, i.e., according to the request of the client system 10.

In general, HTTP, the Internet protocol, has no continuity, and more particularly, is responsive only to the user's request to transfer required information(web page), but makes no continuous information exchange with the user. Therefore, in a case only the HTTP is used, since the user's state information can not be renewed, it is difficult to make an active response to the user's request. According to this, for better session tracking, a preset login maintaining environment, so called “session” is started in the server side independently starting from the login of the user. More particularly, in the present invention, the session exists as a servlet, a server side independent executive object written in “Java” the object-oriented language, and more particularly, as HttpSession, for keep maintaining state information on multiple request and login by the same user(the same browser) for a fixed time period.

In the present invention, after being executed, the session keeps to detect information on the logged in user's client system by using the “Cookie” as information on the user. For maintaining the foregoing state information, the session extracts required information from the transferred cookie(the user's specific information), stores in a designated parameter, and maintains, continuously. And, the extracted information is shared with application programs and/or other objects(servlets) for active response by the web service part 23. By using such a “session”, the user's state information can be maintained and renewed continuously during use of the service, and identity of the authenticated user can be confirmed, continuously.

In order to logout from the service domain, the session is terminated at first in the login maintaining environment terminating step S102. The termination of the session implies removal of HttpSession and information contained therein from the web service part 23. As forms of the session termination, execution of abandon and stopping of additional request during a time period preset in a timeout attribute in the session are used. The timeout attribute is set to be 20 min. basically as far as set separately. In the termination step S102 of the present invention, in order to prevent the user's information from leaking, the abandon is used.

Then, the written user's specific information is deleted S103. In the deleting step S103, the internal processing means in the member management domain deletes the user's specific information which is used continuously and renewed. And, such a deletion of the specific information is carried out both at the user's client system 10 and the web service part 23 by the internal processing means, simultaneously.

Though the login state is terminated through the foregoing steps S101-S103, preferably the member management domain writes up user behaviour S104 after the specific information deleting step S103. In this instance, the internal processing means stores the user's behaviour in the main server system 20 as a database. The behaviour is inclusive of the user's login service list, contents of the service use, and the like, and written with the state information stored in the session shared. As explained, since the portal service fixes a direction of management based on the user's behaviour, the above writing step S104 is required basically.

And, more preferably, a fact of the logout is informed to the user S105. In this instance, the internal processing means B1 transfers a web page informing the logout to the user's client system 10, of which a web page 530 example is shown in FIG. 17. The informing step S105 informs the user that the login state is terminated, and in detail, the user's own specific information is deleted from the main server system 20 and the client system 10. Then, by clicking a confirmation region 530a, the user is allowed to move to other site.

Through a series of these logout steps S80, login to a service domain by using the user's specific information stored in the web browser 100 by others can be prevented, and the leakage of the personal information of the user on an entire network can be prevented under an environment in which many users share one client system 10.

In the meantime, as explained, the cookie ends when the web browser ends basically, and the session ends within the basic set time period of ‘20’ min. Therefore, the user's login may end automatically by merely ending the web browser, even if the separate logout step S100 is not used. However, it is preferable that a logout step is prepared and carried out for construction of a reliable user management environment by preventing leakage of the user information and improper use of the service by others.

As has been explained, the method and system for providing an integrated user management environment to multi-Internet services of the present invention has the following advantages.

First, the method and system of the present invention can provide an integrated user management environment for additional services in a portal service. That is, the present invention integrates and manages user ID information and member information with respect to authentication, makes respective services to share the information, and provides the user with one ID information and a single authentication procedure on the whole. Under this environment, the user can be provided with multi-service by one ID which is managed integrally, and use other services other than the service logged in initially only by single authentication. Therefore, user convenience is enhanced in multi-Internet service in the portal service.

Second, the method and system for providing an integrated user management environment to multi-Internet services can provide the unified user management environment to a newly added service in the portal service, too. And, an existing service can be integrated by simply adding new user information to the integrated user information. These processes can be applicable to a foreign external service integration by using the present invention which has adaptability and flexibility to a spread environment. Accordingly, the present invention permits the portal service to have a flexibility on the whole, and permits the user to use a new service without a separate procedure of registration.

Third, the present invention can provide a wide range of information. The management of the user information and authentication by one user management system permits the portal service to collect a wide range of user behaviour information, that allows modification of existing services and starting of new services.

Fourth, the present invention can provide a higher level of security for the services. That is, the encryption of all user information by using a specially designed algorithm enhances an entire security level for all the services, that in turn enhances a user's reliability.

It will be apparent to those skilled in the art that various modifications and variations can be made in method and system for providing an integrated user management environment to multi-Internet service of the present invention without departing from the spirit or scope of the invention. Thus, it is intended that the present invention cover the modifications and variations of this invention provided they come within the scope of the appended claims and their equivalents.

What is claimed is:

1. A method for providing an integrated user management environment to multi-Internet service, comprising the steps of:
(1) making a user's client system to login a member management domain provided in a web service of a main server system for using a particular internet service;
(2) providing a required single user ID information to the member management domain;
(3) making the member management domain to authenticate the provided user ID information;
(4) transferring specific information on the authenticated user from the member management domain to the user's client system; and,
(5) making the user's client system to login a service domain provided from a service server system by using the specific information,
whereby providing the user with one of multi-Internet service in a portal service by using the single ID information only.

2. A method as claimed in claim 1, wherein the step (1) includes the steps of;
(1-1) making the user's client system to request the service domain for a login, and
(1-2) directing the user's client system to the member management domain instead of the service domain.

3. A method as claimed in claim 2, wherein the step (1-1) includes the steps of making the user's client system to request an internal service domain provided from an internal service server system for a login, or making the user's client system to request an external service domain provided from an external service server system for a login.

4. A method as claimed in claim 1, wherein the steps 3˜5 are carried out by internal processing means included in a web server in the main server system and a service server in the service server system.

5. A method as claimed in claim 4, wherein the internal processing means is the JSP(Java Server Page).

6. A method as claimed in claim 1, wherein the step (3) includes the steps of;
(3-1) making a reference to a data base server in the main server system for user ID information, and
(3-2) comparing the received user ID information with the referred user ID information.

7. A method as claimed in claim 6, wherein the step (3) is carried out linked with data base login means contained in the web server of the main server system.

8. A method as claimed in claim 7, wherein the data base login means is the JDBC(Java Database Connectivity).

9. A method as claimed in claim 6, further comprising the step of providing the required user ID information again when the step (3) is failed.

10. A method as claimed in claim 1, wherein the step (4) includes the steps of;
(4-1) encrypting the authenticated user's specific information in the data base server, and
(4-2) processing the encrypted specific information such that the encrypted specific information can be transferred to the user's client system.

11. A method as claimed in claim 10, wherein the specific information includes user ID information and at least a portion of user's member information.

12. A method as claimed in claim 11, wherein the user ID information includes a user ID and a password.

13. A method as claimed in claim 11, wherein the user member information includes a name, sex, date of birth, address, and the like.

14. A method as claimed in claim 10, wherein the step (4-1) includes the steps of;
(4-1-1) encrypting the authenticated user ID information,
(4-1-2) encrypting 8 bit information in the specific information, and
(4-1-3) encrypting 16 bit information in the specific information.

15. A method as claimed in claim 14, wherein the user ID information is also encrypted in the step (4-1-2).

16. A method as claimed in claim 10, wherein the processed user specific information has a cookie form.

17. A method as claimed in claim 1, wherein the step (5) includes the step of;
login an internal service server domain included in a domain identical to the member management domain, or a plurality of external service server domains each having a domain different from the member management domain.

18. A method as claimed in claim 17, wherein the step of login an internal service server domain includes the steps of;
(18-1) making the internal processing means to direct the user's client system to the internal service domain,
(18-2) making the internal service domain to share the encrypted specific information provided from the user's client system, and
(18-3) making the internal service domain to decrypt the shared specific information.

19. A method as claimed in claim 17, wherein the step of login the plurality of external service server domains includes the steps of;
(19-1) making the member management domain to obtain the specific information transferred to the user by using the internal processing means,
(19-2) directing the user's client system to the external service domain by using the internal processing means, and
(19-3) making the member management domain to transfer the obtained user specific information to the external service domain, and
(19-4) making the external service domain to decrypt the transferred specific information.

20. A method as claimed in claim 17, wherein the service domain serves one of mail, chatting, game, and the like.

21. A method as claimed in claim 18 or 19, wherein the step of decrypting the specific information includes the steps of;
(21-1) decrypting the authenticated user ID information,
(21-2) decrypting 8 bit information in the specific information, and
(21-3) decrypting 16 bit information in the specific information.

22. A method as claimed in claim 1, after the step (5), further comprising the step of the client system re-logging in other service domain provided from service servers of the service server system, whereby providing the user with internal services different from each other, in multi-Internet services in the portal service, repeatedly.

23. A method as claimed in claim 22, wherein the step of the client system re-logging in other service domain includes the step of re-logging in the internal service server domain included in the portal service and the member management domain, or a plurality of external service server domain each having a domain different from the portal service domain.

24. A method as claimed in claim 23, wherein the step of re-logging in the internal service server domain includes the steps of;
making the user's client system to request the other internal service domain,
making the other internal service domain to re-share the encrypted specific information transferred to the user's client system, and
making the other service domain to re-decrypt the specific information.

25. A method as claimed in claim 23, wherein the step of re-logging in a plurality of external service server domain includes the steps of;
making the user's client system to request other external service domain,
making the member management domain to re-obtain the specific information transferred to the user by using the internal processing means,
making the internal processing means to direct the user's client system to the external service domain,
making the member management domain to re-transfer the obtained user specific information to the external service domain, and
making the external service domain to decrypt the transferred specific information.

26. A method as claimed in claim 25, wherein the step for making the user's client system to make an initial login the member management domain, when the step for re-obtaining the specific information is failed.

27. A method as claimed in claim 1, further comprising the step of registering a required member ID before the step of logging in member management domain, whereby providing the user with ID information effective to whole multi-Internet service.

28. A method as claimed in claim 27, wherein the step of registering a required member ID includes the steps of;
making the user's client system to login the membership registration domain in the web server of the main server system,
providing new user ID information and other member information to the membership registration domain,
verifying duplication of the user ID information, and
writing the verified user ID information and other member information on the data base server in the main server system.

29. A method as claimed in claim 1, further comprising the step of making the user's client system logging out of the service domain provided from service servers of the service server system, whereby preventing leakage of user's private information.

30. A method as claimed in claim 29, wherein the step of making the user's client system logging out of the service domain includes the steps of;
(1) making the user's client system to request for a logging out of the service domain,
(2) terminating a login maintaining environment between the user's client system and the service domain, and
(3) deleting the user specific information.

31. A method as claimed in claim 30, wherein the step of making the user's client system logging out of the service domain further includes the steps of writing user's behaviour during the user uses the service after the step (3).

32. A method as claimed in claim 31, wherein the step of making the user's client system logging out of the service domain further includes the steps of informing confirmation of logout to the user's client system after the step (3).

33. A system for providing an integrated user management environment to multi-Internet service, comprising:
a user's client system a communication thereto can be made through an external communication network, for displaying and processing various forms of information;
a main server system a communication thereto can be made through an external communication network, for providing a portal service to the user's client system, and managing Internet services inclusive of the portal service and additional services in connection with the portal service on the whole; and,
a plurality of service server systems a communication thereto can be made through an external communication network, for providing the additional services to the user through the portal service.

34. A system as claimed in claim 33, wherein the user's client system includes means for displaying and processing information on the Internet.

35. A system as claimed in claim 34, wherein the means for displaying and processing information is a web browser.

36. A system as claimed in claim 34, wherein the main server system includes;
a router for connecting the main server system to other network through the Internet,
a web service part connected to the router so as to facilitate communication, for processing information to provide the portal service to the user, and
a data base service part connected to the web service part so as to facilitate communication, for storage and management of information required for the portal service.

37. A system as claimed in claim 36, wherein the web service part includes at least two web servers to cope with simultaneous login of the portal service by a plurality of users.

38. A system as claimed in claim 37, wherein the web server includes an internal processing means for making an interaction between the client system and the web server.

39. A system as claimed in claim 38, wherein the internal processing means is the JPA Jave Server Page).

40. A system as claimed in claim 37 wherein the web server includes data base login means for linking the internal processing means to the data base service part.

41. A system as claimed in claim 40 wherein the data base login means is the JDBC (Java Database Connectivity).

42. A system as claimed in claim 36, wherein the data base service part includes at least two data base servers to cope with simultaneous login of the portal service by a plurality of users.

43. A system as claimed in claim 36, wherein the main server system is connected between the router and the web service part, and further includes a protocol spreading device for preventing the main server system from being overloaded.

44. A system as claimed in claim 33, wherein the service server system includes;
an internal service server system connected to the main server system so as to facilitate communication thereto, and included in the same domain, and
a plurality of external service server system communication thereto can be made through the Internet, and each having a domain different from the main server system.

45. A system as claimed in claim 44, wherein the internal service server system includes;
a router for connecting the internal service server system to other network through the Internet, and
at least one service server connected to the router so as to facilitate communication for providing services different from each other.

46. A system as claimed in claim 44, wherein the external service server system includes;
a router for connecting the external service server system to other network through the Internet,
a web server connected to the router so as to facilitate communication for processing information to provide a particular service to the user, and
a service server connected to the web server so as to facilitate communication for providing the particular service to the user.

47. A system as claimed in claims 45 or 46, wherein the service server includes internal processing means for facilitating interaction between the user's client system and the service server.

48. A system as claimed in claim 47, wherein the internal processing means is the JSP (Java Server Page).
